(19) United States
(12) Patent Application Publication
(10) Pub. No.: US 2002/0071555 A1
(43) Pub. Date: Jun. 13, 2002

(54) Method for recording and reproducing information, recording and reproducing apparatus, recording medium, and method for manufacturing the recording medium

(75) Inventor: Jun Akiyama, Kashihara-shi (JP)

Correspondence Address: DIKE, BRONSTEIN, ROBERTS AND CUSHMAN,, INTELLECTUAL PROPERTY PRACTICE GROUP, EDWARDS & ANGELL, LLP., P.O. BOX 9169, BOSTON, MA, 02209, US

(73) Assignee: Sharp Kabushiki Kaisha

(21) Appl. No.: 09/992,362

(22) Filed: Nov. 14, 2001

(30) Foreign Application Priority Data
Nov. 22, 2000 (JP) 2000-355238

(51) Int. Cl. H04N 7/167

(52) U.S. Cl. 380/203

(57) ABSTRACT

With respect to the disk, a second format such as an error correcting code, a modulation system, and a recording density in an encryption data recording region is different from a first format such as an error correcting code, a modulation system, and a recording density in a user data recording region. A recording and reproducing apparatus for users includes a first reproducing circuit for reproducing information in the first format, a second reproducing circuit for reproducing information in the second format and a first recording circuit for recording information in the first format, but a recording circuit for recording information in the second format is not provided. This makes it possible to provide a method for recording and reproducing information, a recording and reproducing apparatus, a recording medium, and a method for manufacturing the recording medium, which can strongly prevent unauthorized copying of copyright information and secret information, and the like.

### FIELD OF THE INVENTION

The present invention relates to a method for recording and reproducing information, a recording and reproducing apparatus, a recording medium, and a method for manufacturing the recording medium, which can strongly prevent unauthorized copying of copyright information or secret information.

### BACKGROUND OF THE INVENTION

As various types of information, including image information and audio information, are digitized, a volume of digital information has rapidly increased in recent years. Along with this, a rewritable recording medium (information recording medium) suitable for high capacity and high density, or a recording and reproducing apparatus such as an optical disk apparatus and a magnetic disk apparatus has been developed.

On the other hand, the popularization of the Internet has permitted the contents such as music information, image information and book (character) information to be transmitted and received through the network such as the Internet in a short time. Namely, the network distribution, using such way of transmitting and receiving, has been popularized. The contents delivered through this network distribution are usually recorded onto the above-mentioned recording medium and are provided in use for each user.

However, digital information which has been recorded on the above-mentioned rewritable recording medium is easily copied as it is, namely without converting. Therefore, it is necessary to strongly protect the copyrights of music information (audio information), image information, and the like on the network distribution.

As a recording and reproducing method for protecting copyrights, Japanese Laid-Open patent publication No. 238305/1999 (Tokukaihei 11-238305) (published on Aug. 31, 1999; prior art (A)) and Japanese Laid-Open patent publication No. 7247/1997 (Tokukaihei 9-7247)(published on Jan. 10, 1997; prior art (B)) describe a method for recording an encryption key, and the like on a recording medium.

More specifically, prior art (A) describes a recording and reproducing method for recording encrypted data in a modulation system different from that of recording data.

In the above-mentioned recording and reproducing method, recording data is first encrypted by using the encryption data from a encryption key generating circuit when recording the recording data onto an optical disk (recording medium). Then, at the same time the encrypted recording data is stored in a data recording area on the optical disk, the encrypted data is recorded in a predetermined sector.

In addition, the encryption data is recorded by the modulation circuit and the modulation system different from those of the recording data.

On the other hand, when reproducing, at the same time the encrypted data is read out from the predetermined sector, the recording data is read out from the recording data area. The encryption data and the recording data are demodulated by different demodulation circuits. A reproduction signal is obtained by decoding the encryption of the recording data with the encryption data.

For the realization of such a recording and reproducing method, the recording and reproducing apparatus includes a main modulation circuit and a main demodulation circuit for recording and reproducing the recording data, as well as a sub-modulation circuit and a sub-demodulation circuit for recording and reproducing the encrypted data.

That is, if the recording and reproducing apparatus is used without the main modulation circuit and the main demodulation circuit for recording and reproducing the recording data as well as the sub-modulation circuit and the sub-demodulation circuit for recording and reproducing the encryption data, it is impossible to reproduce encryption data which has been recorded in the modulation system different from that of the recording data.

Thus, it is impossible for a common apparatus to reproduce the encryption data which has recorded in the modulation system different from that of the recording data, so the prevention of unauthorized copying can be realized.

Also, the above-mentioned prior art (B) describes method for recording and reproducing, whereby media ID data is recorded as a nonvolatile mark in the form of not permitting the user to overwrite.

In this method for recording and reproducing, a usual rewritable recording mark is formed on a magneto-optical disk, and media ID data is recorded as a nonvolatile mark. This recording is performed at a lower linear velocity or with a higher laser power than when forming the recording mark. Then, the erasing operation is repeated for predetermined times while applying a magnetic field on the disk.

This makes it impossible to reproduce the media ID data at a low temperature, that is, the media ID data becomes the data which is reproduced at a high temperature.

The reproduction of recording data from this kind of magneto-optical disk is realized in the state where the rise in temperature in reproducing makes it possible to reproduce the media ID data. However , right after this magneto-optical disk is inserted into a drive, the nonvolatile mark (media ID data) cannot be reproduced accurately.

Therefore, even if unauthorized copying was attempted, inaccurate media ID data would be recorded onto the copied product. As a result, the reproduction of the recording data could be prevented.

However, in the recording and reproducing method described in prior art (A), it would be possible to reproduce and record encryption data between the recording and reproducing apparatuses which include the same main modulation circuit, main demodulation circuit, sub-modulation circuit and sub-demodulation circuit. As a result, unauthorized copying would be easily performed.

Also, for preventing unauthorized copying, it is not realistic in terms of cost and configuration to differ the modulation system of encryption data for each recording and reproducing apparatus, that is, to produce a different modulation circuit and demodulation circuit corresponding to every single recording and reproducing apparatus.

Furthermore, in the recording and reproducing method described in the above-mentioned prior art (B), the media ID data (nonvolatile mark) is formed by recording at a lower linear velocity or with a higher laser power than when recording the recording data. Therefore, it is difficult to record the media ID data in a common recording apparatus, and it is required that media ID data be recorded by the special recording apparatus which includes a spindle motor that is rotable at a low linear velocity and a laser diode that is capable of producing a high laser power.

Thus, a need for the special recording and reproducing apparatus brings upon increasing costs for producing the apparatus. Also, it is usually required to prepare the apparatus for detecting the disk and the apparatus for recording the media ID data separately. Because of this, it takes time to produce magneto-optical disks.

Furthermore, the recording and reproducing apparatus can reproduce the media ID data only after it becomes high in temperature, which makes it possible to reproduce the recording data. Therefore, the reproduction after becoming high in temperature causes a decrease in access speed.

### SUMMARY OF THE INVENTION

It is a main object of the present invention to provide a method for recording and reproducing information, a recording and reproducing apparatus, a recording medium and a method for manufacturing the recording medium, which can strongly prevent unauthorized copying of copyright information and secret information, and the like without the increase in costs and the decrease in access speed.

The above-mentioned object can be achieved by a method for recording and reproducing information of the present invention, the method recording and reproducing information with respect to a recording medium including a data recording region which is defined to record information in a predetermined recording system and a first format, and an encryption data recording region in which encryption information required to reproduce data recorded in the data recording region is recorded in the recording system and a second format different from the first format, said method recording information in the data recording region in the recording system and the first format; after encrypting the information using the encryption information which was reproduced in the recording system and the second format from the encryption data recording region in the recording medium, and said method reproducing information by reading out the encrypted information recorded in the data recording region in the recording system and the first format, and by decrypting the encrypted information using the encryption information which was reproduced from the encryption data recording region in the recording medium in the recording system and the second format.

According to the above-mentioned method, it is possible to record and reproduce information using encryption information which the recording medium includes. The encryption information is recorded in the format different from that used by a user to record information in the data recording region.

Therefore, encryption information is not copied, so it is possible to strongly prevent unauthorized copying of copyright information and secret information, and the like.

A recording medium of the present invention comprises: a data recording region which is defined to record data in a predetermined recording system and a first format; and an encryption data recording region in which encryption information required to encrypt information to be recorded in the data recording region and to reproduce recorded information from the data recording region is recorded in the recording system, wherein the encryption information is recorded in the data recording region in a second format different from the first format.

A recording and reproducing apparatus of the present invention records and reproduces information with respect to a recording medium including a data recording region which is defined to record data in a predetermined recording system and a first format, and an encryption data recording region in which encryption information required to encrypt information to be recorded in the data recording region and to reproduce recorded information from the data recording region is recorded in the recording system, the encryption information being recorded in the encryption data recording region in a second format different from the first format, said recording and reproducing apparatus comprising: reproducing means for reproducing information in the recording system and the first format, and in the recording system and the second format; and sole recording means for recording information on the recording medium only in the recording system and the first format, but not in the recording system and the second format.

Further, a recording and reproducing apparatus may comprise: reproducing means for reproducing information recorded in a predetermined recording system and n kinds of format; and sole recording means for recording information only in the recording system and m (1≦m<n) format in the n kinds of format.

According to the above-mentioned arrangement, the recording circuit for recording information in the second format or the recording circuit for recording information in n-m kinds of recording format are not provided.

Therefore, in the recording and reproducing apparatus, it is impossible to rewrite encryption information recorded in the second format or one of n-m kinds of recording format.

With this, in an attempt to copy information recorded on one recording medium (a first recording medium) to another recording medium (a second recording medium), while it may be possible to copy information recorded on the first recording medium in its encrypted form to the second recording medium, it is impossible to copy encryption information necessary for decrypting the encryption information. As a result, it is possible to strongly prevent unauthorized copying of copyright information and secret information, and the like without the increase in costs and the decrease in access speed.

According to a method for manufacturing a recording medium of the present invention, the recording medium includes a data recording region which is defined to record information in a predetermined recording system and a first format, and an encryption data recording region in which encryption information required to encrypt information to be recorded in the data recording region and to reproduce recorded information from the data recording region is recorded in the recording system and a second format different from the first format, said method comprising the step of: (1) detecting defects by recording and reproducing test data in the data recording region in the first format; and (2) recording the encryption information in the encryption data recording region in the second format, said step (1) and said step (2) being continuously carried out in one apparatus.

According to the above-mentioned manufacturing method, it is possible to record encryption information on the recording medium as well as to detect defects. This allows the time for manufacturing the recording medium to be shortened, and for example, allows the apparatus for manufacturing the recording medium to be manufactured at low cost.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is an explanatory drawing illustrating a structure of a disk according to an embodiment of the present invention.

FIG. 2 is an explanatory drawing illustrating a structure of relevant parts of a recording and reproducing apparatus for recording and reproducing information with respect to the disk shown in FIG. 1.

FIG .3 is an explanatory drawing illustrating a structure of relevant parts of a detecting apparatus for manufacturing disks.

FIG. 4 is a flowchart illustrating an example of processes for manufacturing disks.

FIG. 5 is a flowchart illustrating an example of recording methods with respect to the disk.

FIG. 6 is a flowchart illustrating an example of reproducing methods with respect to the disk.

### DESCRIPTION OF THE EMBODIMENTS

(Embodiment 1)

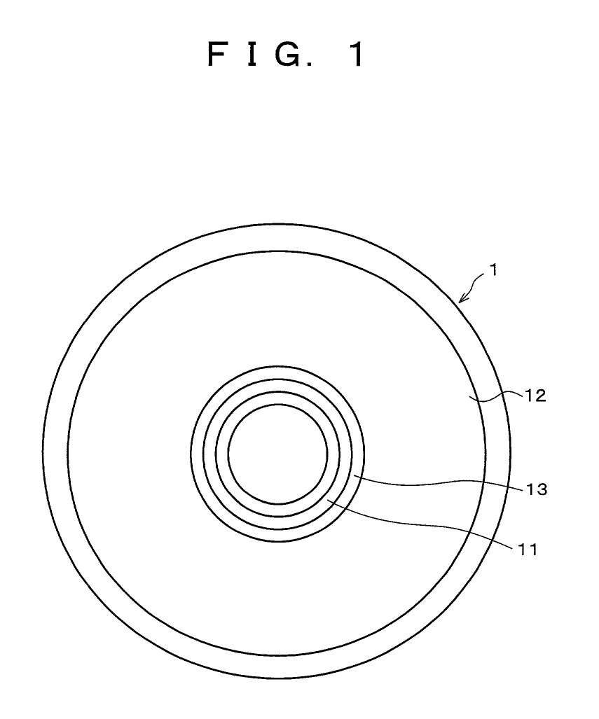

Referring to FIGS. 1 through 4, an embodiment according to the present invention is described below.

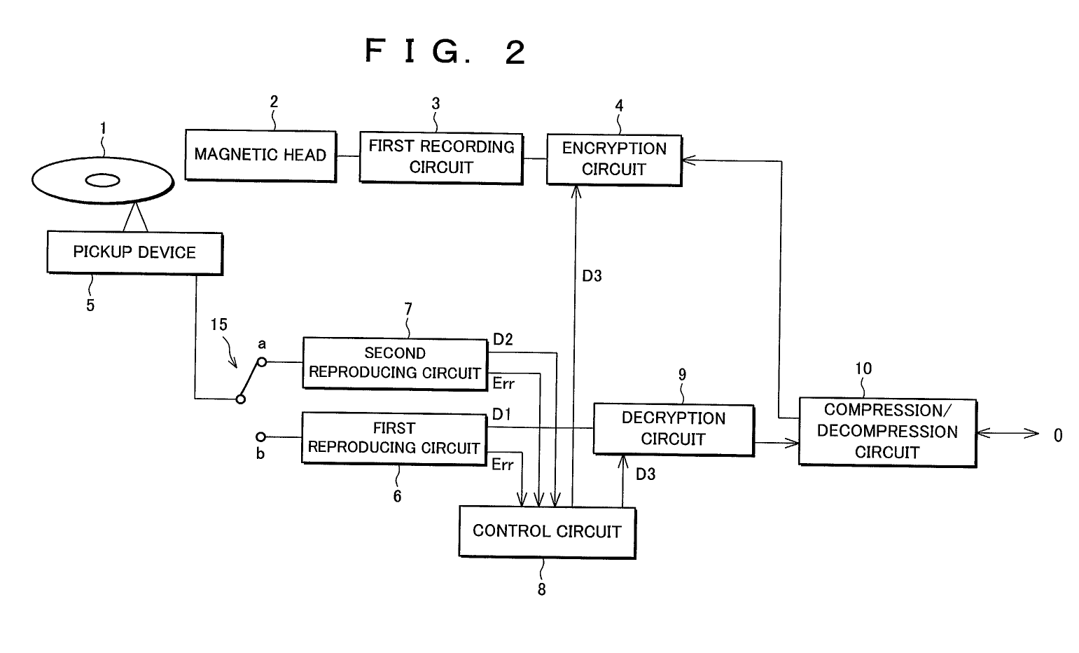

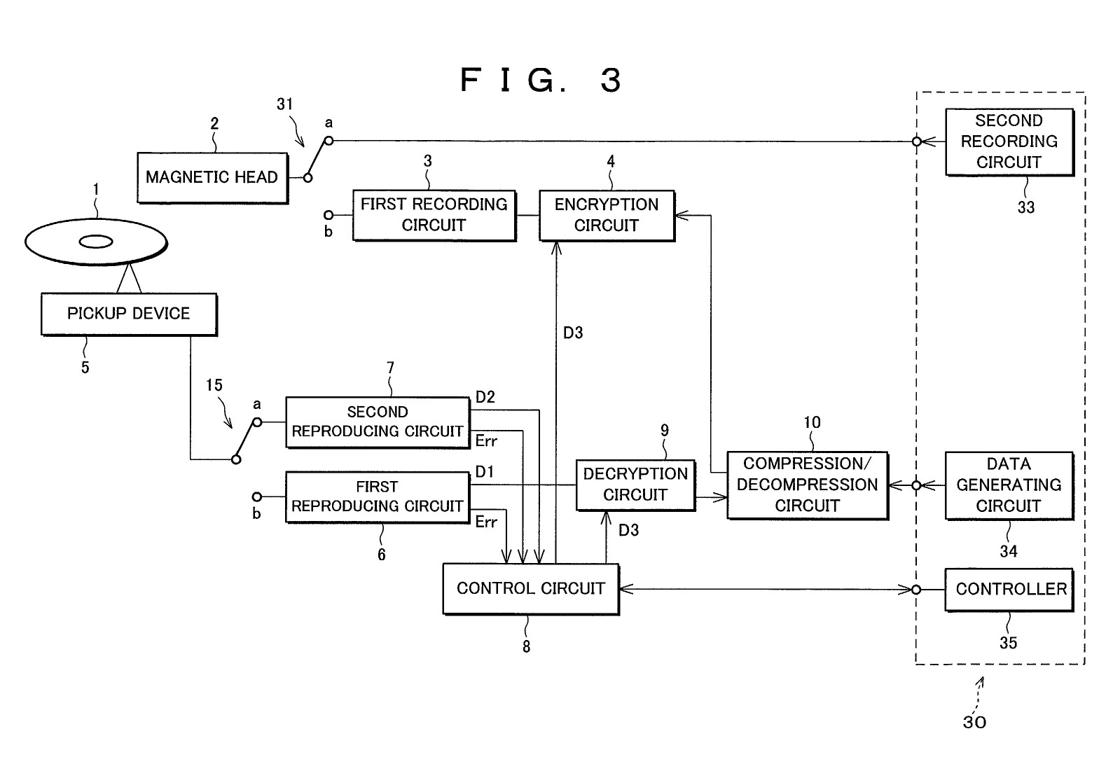

As shown in FIG. 2, a recording and reproducing apparatus (magneto-optical disk apparatus) according to the present embodiment includes a magnetic head 2, a first recording circuit (only recording means) 3, an encryption circuit 4, a pickup device 5, a first reproducing circuit (reproducing means) 6, a second reproducing circuit (reproducing means) 7, a control circuit 8, a decryption circuit 9, and a compression/decompression circuit 10, so as to record and reproduce information (data) with respect to a disk (magneto-optical disk, recording medium) 1.

As shown in FIG. 1, the disk 1 includes at least an encryption data recording region 11 and a user data recording region (data recording region) 12. Furthermore, a lead-in area 13 is included herein.

In the encryption data recording region 11, disk identification information has been recorded in advance by magneto-optical recording (hereinafter “recording”) before the disk 1 goes on sale. Disk identification information (identification information) includes production number data and encryption key data (encryption information). The encryption data recording region 11 is disposed on the inner periphery side of the disk 1.

The encryption key data is data which is used when recording data (described below) to be recorded in the user data recording region 12 is encrypted, and when recording data recorded in the user data recording region 12 is decrypted. Preferably, the encryption key data is recorded as individual data given to each disk 1 or as data randomly selected from many data so that the probability of agreement between plural disks 1 may be considerably low.

The production number data is recorded as individual data given to each disk 1. If unauthorized copying was performed, the production number data could be available for the search for the source of the unauthorized copying.

Furthermore, the disk identification information may not include the production number data or may further include another data.

Also, the encryption data recording region 11 is not limited to be disposed on the inner periphery side of the disk 1. For example, it may be disposed on the outer periphery side of the disk 1 or between a predetermined zone and the zone adjoining it on the disk 1.

The user data recording region 12 is the region in which data is recorded by a user. Usually, disk 1 goes on sale in the condition that the user data recording region 12 is a blank region carrying no data. The user data recording region 12 is usually divided into each unit of sector and each unit of zone.

Furthermore, data (e.g., defect management information) may be recorded in a part of the user data recording region 12 on the disk 1 before the disk 1 goes on sale.

Since the disk identification information includes important information such as encryption key data for the system operation, it is recorded for plural times in the encryption data recording region 11 in this embodiment. The disk identification information is recorded at different positions in the circumferential direction in the encryption data recording region 11.

In this way, even if the disk identification information could not be recorded accurately at one position of the circumferential direction because of defect, etc., other positions of the circumferential direction at a distance are not affected by the same defect. Therefore, it is possible to record and reproduce data normally with respect to the disk 1. Thus, recording the disk identification information for plural times is expected to improve the reliability of data recorded on the disk 1.

In addition, the recording format (first format) of the user data recording region 12 is defined in advance in the specification, etc. On the other hand, the disk identification information is recorded in advance in a recording format (second format) different from the first format.

More specifically, the recording format indicates recording density (linear density, track density), modulation system, error correcting system, and defect management system. The first format is set to be different from the second format in at least one of the recording density, the modulation system, the error correcting system, and the defect management system.

As mentioned above, the disk identification information recorded in the second format includes indispensable information such as the encryption key data for the system operation. With this, if these information could not be read accurately for any reasons, it would be impossible to record and/or reproduce the recording data in or from the user data recording region 12.

For this reason, it is preferable that the reproduction signal from the encryption data recording region 11 is better in quality compared with that from the user data recording region 12. Accordingly, it is preferable that the recording format of the second format produces better reproduction quality than the first format.

With respect to modulation system, there are, for example, FM, MFM, PE, EFM, (1, 7)RLL, (2, 7)RLL, NRZI, etc. Here, different one of these systems is selected for the first format and the second format.

With respect to error correction system, there are systems wherein multiplexed code and interleave, etc. are added to the error correction codes such as humming code, BCH code, RS code, folded code, etc., for the strengthening of the error correcting ability of these codes. Here, different one of these error correction systems is selected for the first format and the second format.

Also, different recording density is selected for the first format and the second format. More specifically, the quality of reproduction is improved by setting the second format to be lower in recording density than the first format.

Here, the modulation system, the error correcting system, and the recording density of the first format differ from those of the second format. However, for example, only the error correcting system of the first format may be different from that of the second format.

In the lead-in area 13, necessary information for the system operation is recorded in the form of changing disk patterns such as pits. The recording format of the lead-in area 13 is the first format same as that of the user data recording region 12.

Note that, the recording format of the lead-in area 13 is not necessarily the same as that of the user data recording region 12 (first format). For example, it may be the same format as that of the encryption data recording region 11 (second format) or the format other than the first or second format.

Here, data is recorded in the lead-in area 13 with the magneto-optical recording system, as in the user data recording region 12 and the encryption data recording region 11.

A method for recording and reproducing data in the recording and reproducing apparatus with respect to the disk 1 is described below.

The recording and reproducing apparatus records or reproduces data after the starting operation.

Referring to FIG.2, the starting operation of the recording and reproducing apparatus is first described below.

After the disk 1 is set in the recording and reproducing apparatus, the pickup device 5 accesses to the lead-in area 13, and the first reproducing circuit 6 reproduces necessary information. At this moment, a switch 15 is being connected to a contact b. Thereafter, test read operation and test write operation, etc. is performed for optimizing the intensity of the light beam radiated from the pickup device 5 onto the disk 1.

Then, the switch 15 is connected to a contact a, and disk identification information is read out from the encryption data recording region 11. The data signal of the disk identification information outputted from the pickup device 5 is inputted to the second reproducing circuit 7. In the second reproducing circuit 7, the disk identification information is reproduced by decoding and error correcting of the data signal based on the second format.

In case where the second reproducing circuit 7 fails to read out the disk identification information accurately, error information is transmitted to the control circuit 8 as Err signal (Err). Since the disk identification information is formed at plural different positions in the circumferential direction, other disk identification information is reproduced even if the above-mentioned error occurs at one position of the circumferential direction.

Since the disk identification information is recorded for plural times on the disk 1 when manufacturing (described below), it is supposed to be read out accurately at any one of the different positions of the circumferential direction. Therefore, by repeating read-out at different positions in the circumferential direction, the disk identification information can be read out normally without fail in the recording and reproducing apparatus used by users.

Then, the control circuit 8 generates encryption key data D3 based on the data signal D2 of the disk identification information accurately read out from the second reproducing circuit 7, and the encryption key data D3 is transmitted to the encryption circuit 4 and the decryption circuit 9.

The starting operation is finished by the above procedure, enabling recording or reproducing of data.

Next, the recording operation of the recording and reproducing apparatus is described below.

Data given from the outside such as video/audio information (e.g., contents data (information) delivered via the Internet) is first inputted to the compression/decompression circuit 10. After compressing the input data, the compression/decompression circuit 10 outputs it to the encryption circuit 4.

The encryption circuit 4 performs encryption process on the input data from the compression/decompression circuit 10 using the encryption key data D3.

In the first recording circuit 3, the data encrypted in the encryption circuit 4 is recorded as the recording data in the user data recording region 12 with the first format. That means, on the basis of the recording data which was subjected to the predetermined error correcting and modulation, the first recording circuit 3 operates the magnetic head 2. The magnetic head 2 applies the magnetic field according to the recording data onto the disk 1 so as to perform the magneto-optical recording by the magnetic field modulation recording.

Note that, the recording and reproducing apparatus shown in FIG. 2 is composed for magnetic field modulation recording. However, for example, it can also adopt optical modulation recording. In this case, the recording and reproducing apparatus is adapted to operate the pickup device 5 by the signal from the first recording circuit 3.

Next, the reproducing operation of the recording and reproducing apparatus is described below. Here, the intensity of a light beam radiated from the pickup device 5 to reproduce data is controlled to be suitable for reproduction.

The pickup device 5 fist accesses a target spot in the user data recording region 12 and divides the light beam reflected from the disk 1 into a servo signal and a data signal, which are detected by a photo-detector provided in the pickup device 5.

The data signal so obtained is read out (reproduced) after modulating and error correcting in the first format by the first reproducing circuit 6. Here, in the first reproducing circuit 6, error information derived from a failure to read the data signal accurately is transmitted to the control circuit 8 as Err signal (Err).

Further, the first reproducing circuit 6 outputs the recording data D1 as the reproduced data signal to the decryption circuit 9. The decryption circuit 9 performs the decrypting process of the recording data D1 with the encryption key data D3 outputted from the control circuit 8 and outputs it to compression/decompression circuit 10.

For normal decryption, the encryption key data used for encrypting data when recording (the encryption key data D3 for the encryption circuit 4) must agree with that used for decrypting data when reproducing (the encryption key data D3 for the decryption circuit 9).

For example, plural types of encryption key data may be recorded on the disk 1. In this case, however, it would be necessary to record in the TOC region of the disk 1 which encryption key data had been used for recording.

Then, the decrypted data in the decryption circuit 9 is outputted as video/audio information after the decompression process by the compression/decompression circuit 10.

Thus, since the disk identification information used for recording and reproducing data is recorded on the disk 1, the data can be reproduced even if the disk 1 in which data requiring copyright protection is recorded by the recording and reproducing apparatus of one user is loaded in the recording and reproducing apparatus of other user. This makes it possible to portably provide the disk 1 and to improve the convenience for the users of the disk 1.

Further, since the recording and reproducing apparatus includes no recording circuit which records disk identification information, copying the encryption key data D3 to other disks is not allowed. Thus, the recording and reproducing apparatus cannot be used for unauthorized copying of recording data which requires copyright protection from one disk to another.

Since the error correcting system and modulation system used for recording and reproducing with respect to the user data recording region 12 are different from those used for recording and reproducing the disk identification information, the first recording circuit 3 cannot be used for recording the disk identification information.

Note that, the foregoing described the case where the user data recording region 12 is blank prior to recording. As a matter of course, it would be possible that the recording and reproducing apparatus rewrites data which has been already recorded in the user data recording region 12 in order to record other data in it.

As described, the recording and reproducing apparatus for general users can reproduce information recorded in the first format and the second format on the disk 1. Also, the recording and reproducing apparatus can record information in the first format on the disk 1, but not in the second format.

The second format is kept secret for general users. Accordingly, it is practically impossible to modify the recording and reproducing apparatus so as to record information in the second format.

Further, for example, when recording the contents (data, information) which require copyright protection, purchased via network distribution, on the disk 1, the recording and reproducing apparatus reproduces the disk identification information recorded in the second format on the disk 1, first.

Then, the recording and reproducing apparatus encrypts the content data with the disk identification information to generate the recording data, and magneto-optically records the recording data in the user data recording region 12 in the first format.

On the other hand, when reproducing the content data, the recording and reproducing apparatus reads out the disk identification information recorded in the second format on the disk 1, as well as the recording data recorded in the first format in the user data recording region 12.

Then, the recording and reproducing apparatus decryptes the recording data with the encryption key data included in the disk identification information so as to reproduce the content data.

This method for recording and reproducing information makes it possible to encrypt data for recording and decrypt the encrypted data for reproducing. Also, the disk identification information pre-recorded in the second format on the disk 1 cannot be rewritten by the recording and reproducing apparatus available for users.

With this, in an attempt to copy data of one disk 1 to another, while it may be possible to copy the as encrypted recording data (the recording data as it is) from one disk 1 to another, it is impossible to copy the disk identification information necessary for decrypting the encryption.

Therefore, it is possible to strongly prevent unauthorized copying of the recording data, namely the content data.

An example of process for manufacturing the disk 1 (manufacturing method) is described below. In the process for manufacturing the disk 1, it is necessary to detect (certify operation) for finding whether the disk 1 is a defective product (defective disk) or not. The operation is performed with a detecting apparatus for manufacturing disks (recording medium manufacturing apparatus) as shown in FIG.3.

The detecting apparatus for manufacturing disks shown in FIG. 3 is made up of circuits in a region 30 surrounded by a broken line and a switch 31 in FIG. 3 added to the recording and reproducing apparatus shown in FIG. 2. The detecting apparatus for manufacturing disks records the disk identification information on the encryption data recording region 11 at the same time it tests the disk 1. This means that the detecting apparatus for manufacturing disks, which serves as the recording apparatus which records the disk identification information on the disk 1, can be made only by adding a second recording circuit 33, a data generating circuit 34, a controller 35, and a switch 31 to the recording and reproducing apparatus.

This makes it possible to manufacture the recording apparatus for recording the disk identification information on the disk 1 at a quite low cost. Further, the disk identification information can be recorded by the detecting apparatus for manufacturing disks, which shortens the time for manufacturing the disk 1.

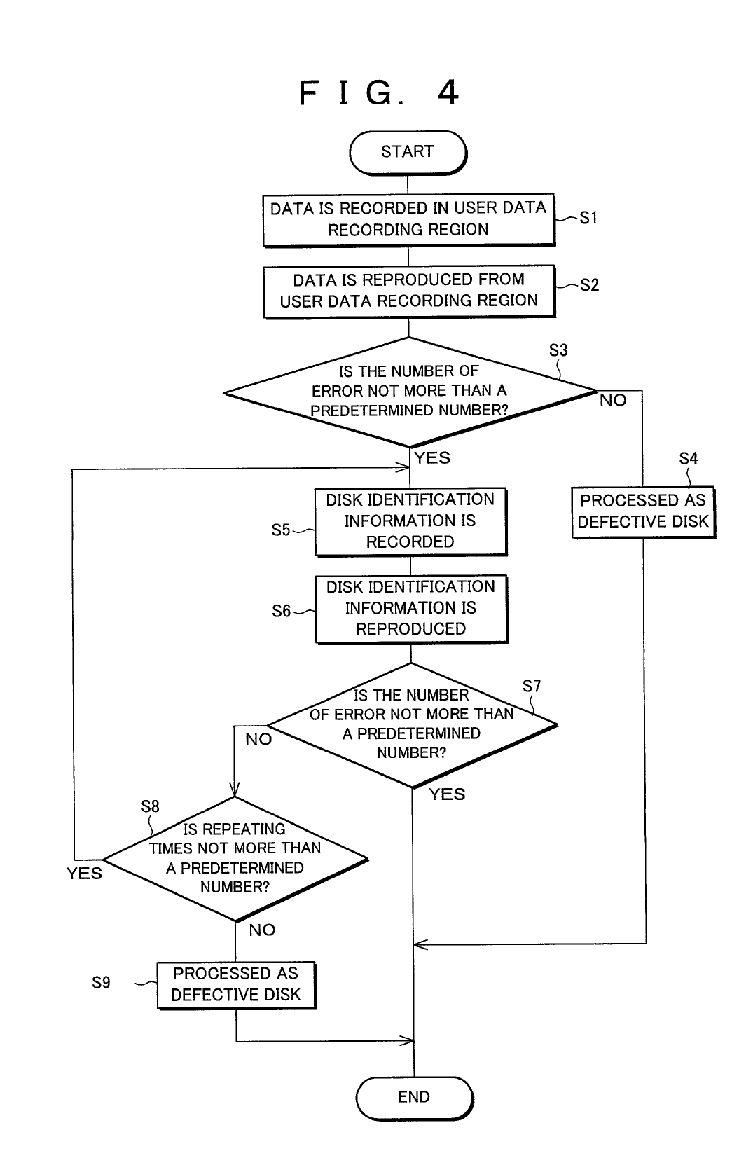

Referring to FIG. 4, an example of process for manufacturing the disk 1 is described below.

First, certify operation is performed on the disk 1 after a coating process. Certify operation means the operation which detects unavailable region (defect) in the recording region on the disk 1 by recording and reproducing data with respect to the recording region of the disk 1.

The location information of defect found here is registered, for example, in the defect management information region on the disk 1. From this time on, it is managed so that the registered region cannot be used for recording and reproducing data. In the case where the number of defects in the disk 1 is more than the predetermined number of defects, the disk 1 is processed as a defective disk.

Referring to FIG. 3 and FIG. 4, the certify operation is described in detail below.

First, the disk 1 after coating process is installed on a turn table (not shown) for rotation. Before recording operation, the switch 31 and the switch 15 are connected to a contact b. A light beam is radiated from the bottom to the disk 1 through an object glass provided in the pickup device 5. The intensity of the light beam is controlled so as to be a suitable intensity. However, it is preferable to perform the operation (test write operation, test read operation) for optimizing the intensity of the light beam before recording.

Next, the data generating circuit 34 generates test data. The test data is compressed by the compression/decompression circuit 10 and is subjected to the encryption process in the encryption circuit 4. At this time, encryption key data for testing is supplied from the controller 35 to the encryption circuit 4 via the control circuit 8. This encryption key data for testing is temporarily used only when testing.

After that, the test data which has been encrypted is inputted to the first recording circuit 3. In the first recording circuit 3, a predetermined error correcting code is added to the test data which has been encrypted, and the test data is outputted after further modulation.

The output from the first recording circuit 3 is given to the magnetic head 2, which generates a magnetic field according to the test data. The test data is recorded in the user data recording region 12 with the light beam radiated from the pickup device 5 and the magnetic field generated from the magnetic head 2 (Step S1).

In addition, the test data may be directly supplied to the first recording circuit 3. In this case, the encryption key data for testing is not necessary.

Then, the light beam reflected off the disk 1 is detected by the photo-detector provided inside the pickup device 5, and divided into a servo signal and a data signal. The data signal so obtained is demodulated and error-corrected by the first reproducing circuit 6 to be reproduced (Step S2).

At this time, the error information that indicates a failure to read out the data signal accurately in the first reproducing circuit 6 is transmitted to the control circuit 8 as an Err signal from the first reproducing circuit 6. In addition, the first reproducing circuit 6 also outputs the recording data D1 as the reproduced data signal. However, the recording data D1 is not used in the certify operation.

Next, the control circuit 8 determines whether the disk 1 is defective or not on the basis of the obtained error information (Err signal), that is, whether the number of errors is at or below than a predetermined number (Step S3). The control circuit 8 inputs the error information and the result of determining whether or not the disk is defective into the controller 35.

In case where the disk 1 is defective, that is, when the number of errors is more than the predetermined number, the controller 35 discharges the disk 1 from the detecting apparatus for manufacturing disks, and here testing is completed (Step S4).

On the other hand, in case where the disk 1 is not defective, that is, when the number of errors is at or below the predetermined number, the control circuit 8 generates the defect management information and records it in a predetermined region.

And, the switch 31 and 15 are connected to a contact a. With this, the disk identification information is added to the magnetic head 2 from the second recording circuit 33. The second recording circuit 33 includes a modulation circuit and an error correcting circuit as the first recording circuit 3 does.

Next, with the light beam radiated from the pickup device 5 and the magnetic field generated from the magnetic head 2, the disk identification information is recorded onto the disk 1 (Step S5). This disk identification information is recorded at least at plural different positions in the circumferential direction.

Thus, in this embodiment, the recording system of the disk identification information in the detecting apparatus for manufacturing disks (magneto-optical recording system) is the same as that of data in the recording and reproducing apparatus for users (magneto-optical recording system). Also, the intensity of the light beam, the strength of the magnetic field, and the linear velocity of the disk 1 used to record the disk identification information in the detecting apparatus for manufacturing disks are the same as those used to record data in the user data recording region 12 on the disk 1 in the recording and reproducing apparatus for users.

For this, without the change of a laser diode or a spindle motor in the recording and reproducing apparatus for users on sale, only the addition of the circuit makes the recording and reproducing apparatus for users available for the detecting apparatus for manufacturing disks.

Next, the data signal which was outputted from the pickup device 5 is inputted to the second reproducing circuit 7. In the second reproducing circuit 7, the data signal is demodulated and error-corrected in the second format. By this process, the disk identification information is reproduced (Step S6).

At this time, error information which indicates a failure to read out the data signal of the disk identification information accurately is transmitted to the control circuit 8 as an Err signal from the second reproducing circuit 7.

When the number of errors is at or below the predetermined number, the recording is deemed to be a success, and the test is completed. That is, the disk 1 is determined as passed test only when the data is read out accurately.

Here, as described above, disk identification information is to be recorded at plural positions. Therefore, in case where the number of errors is more than a predetermined number, the disk identification information is recorded and reproduced again within a range of not exceeding a predetermined number of times. That is, the disk identification information recorded at a different position is reproduced to evaluate pass or fail on the basis of the error information (the number of errors) (Step S5 to S8). The disk is judged to be defective when data cannot be recorded properly even after repeating recording and reproducing the disk identification information for a predetermined number of times (Step S8, S9).

As described above, in the manufacturing method of the disk 1, the disk identification information is recorded in the rewritable recording system that is the same as the recording system in which data is recorded on the disk 1 by user. Therefore, if the data as intended to record is not recorded properly, re-recording is possible.

Thus, even in cases where recording is not carried out properly, for example, by a shock to the detecting apparatus for manufacturing disks, the proper recording possible by the re-recording. Therefore, yield can be improved.

In addition, when re-recording, for the prevention of the influence of relatively small defect, the track position of recording and reproducing data may be changed, or the same track position may be used to record and reproduce data for the predetermined times.

In this manner, recording the disk identification information and detecting the disk 1 can be performed in a series of flows. Therefore, this allows the number of manufacturing processes to be reduced and a manufacturing time (period) to be shortened because recording and detecting are not required to be performed in separate apparatuses.

Also, the test data which was recorded in the disk 1 by the above-mentioned certifying operation is usually erased before the disk 1 goes on sale for users.

In addition, the disk 1 is not limited to the magneto-optical disk. Alternatively, for example, the magnetic disk such as a floppy disk and a hard disk, and the optical disk such as CD-ROM/MO/MD/DVD may be used as well.

(Embodiment 2)

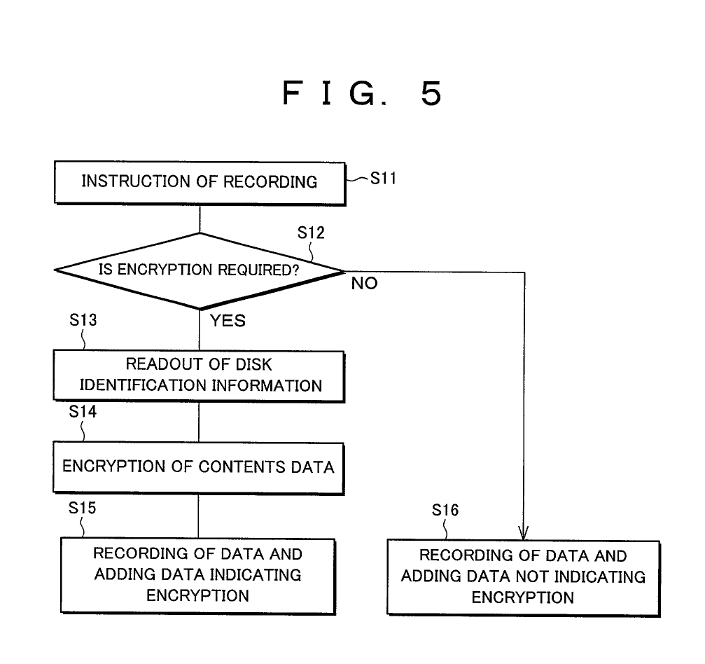

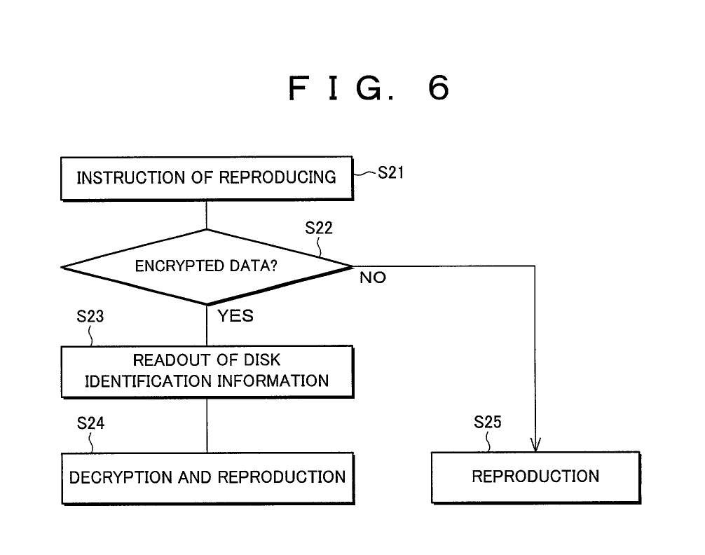

Referring to FIG.5 and FIG.6, a second embodiment according to the present invention is described below. Note that, for the constituting elements that have the same functions as those of the above-mentioned embodiment 1, the same reference numerals are given and explanations thereof are omitted here.

A recording and reproducing apparatus according to the present embodiment records and reproduces information (data) which includes information requring copyright protection and copy-free information not requiring copyright protection, onto the disk 1 described in the embodiment 1.

Referring to FIG. 5, the following explains a method for recording the data (information) onto the disk 1 in the recording and reproducing apparatus according to the present embodiment.

When the instruction of recording data is provided from a user (Step S11), it is judged whether or not the encryption of the data is required (Step S12).

In this judgement of encryption, for example, in case of recording contents data (data) delivered from the Internet, it is detected whether or not the contents data includes data indicating it is the object of copyright protection.

In case where the data indicative of copyright protection is included, it is judged that the encryption is required. In case where the data indicative of copyright protection is not included, it is judged that the encryption is not required.

Also, the contents data is generally delivered from a distributing computer in encrypted form. The recording and reproducing apparatus or the user computer as an upper apparatus performs a process for decrypting (decoding) the encrypted contents data.

Accordingly, whether or not encryption is required may be decided by determining whether or not a process for decrypting (a process for decoding) has been performed in the recording and reproducing apparatus or the user computer. That is, in case where the decrypting operation has been performed in the recording and reproducing apparatus or the user computer, it may be determined that encryption is required. In case where the decrypting operation has not been performed, it may be determined that encryption is not required.

Also, the recording and reproducing apparatus or the user computer may be used to allow the user to directly input the information which indicates whether or not encryption is required, so that the recording and reproducing apparatus can determine whether or not the encryption of data is required on the basis of the information entered by the user. This makes it possible to protect the data which the user has created and edited.

Next, in case where it is judged in Step S12 that the encryption is required (if the result of judgement in step S12 is “Yes”), the disk identification information is read out from the encryption data recording region 11 on the disk 1 by using the second reproduction circuit 7 (Step S13).

Using the encryption key data included in the disk identification information, a process for encrypting the contents data is performed by the encryption circuit 4 (Step S14) to generate the recording data.

Then, the encrypted recording data is recorded in the user data recording region 12 with the pickup device 5 and the magnetic head 2, as well as other information such as data of the recording data capacity and additional data indicating that it has been encrypted, in a TOC region where recorded contents of the disk 1 are managed (Step S15).

On the other hand, in case where it is judged in Step S12 that encryption is not required (if the result of judgement in Step S12 is “NO”), data is recorded in the user data recording region 12 with the pickup device 5 and the magnetic head 2, as well as other information such as data of recording data capacity and additional data indicating that it has not been encrypted, in the TOC region where recorded contents of the disk 1 are managed (Step S16).

Next, referring to FIG. 6, the following explains a method for reproducing the data (information) from the disk 1 in the recording and reproducing apparatus according to the present embodiment.

First, when the instruction of reproducing data is provided from a user (Step S21), the TOC region is reproduced to judge whether or not the target reproduction data is the encrypted data (Step S22). This judgement can be made by checking the additional data added in Step S15 and S16.

In case where the reproduction data is the encrypted data (if the result of judgement in step S22 is “YES”), the disk identification information is read out from the encryption data recording region 11 on the disk 1 by using the second reproducing circuit 7 (Step S23).

Then, using the encryption key data included in the disk identification information which has been read out in Step S23, the recording data recorded in the user data recording region 12 is decrypted and reproduced by the first reproducing circuit 6 (Step S24).

On the other hand, in case where it is judged that it has not encrypted (if the result of judgement in Step S22 is “No”), the data which is recorded in the user data recording region 12 is reproduced as it is by the first reproducing circuit 6 (Step S25).

With this, even if data which requires copyright protection and data which does not require copyright protection, that is, copy-free data coexist in the disk 1, they can be recorded and reproduced.

Note that, the present invention is suitable not only for the magneto-optical recording and reproducing system, but also for the phase change recording and reproducing system and the magnetic recording and reproducing system. In the case, the system of recording and reproducing is changed to adapt to the change of phase recording and reproducing system and the magnetic recording and reproducing system.

Although the foregoing embodiments 1 and 2 described the case where the recording data is recorded in one recording format (the first format) in the user data recording region 12, and the encryption information is recorded in other recording format (the second format) in the encryption data recording region 11, it is to be understood that the present invention is not limited to these embodiments.

For example, the data may be recorded with m (m≧1) kinds of recording format in the user data recording region 12 and in n-m ((n-m)≧1) kinds of recording format, which is different from the above m (m≧1) kinds of recording format, in the encryption data recording region 11.

In this case, the recording and reproducing apparatus must include reproducing means which can reproduce n (=m+(n-m)) kinds of recording format as well as sole recording means which can record only m (1≦m<n) kinds of recording format included in n kinds of recording format.

In this manner, the recording format such as the error correcting code, modulation system, recording density of the encryption data recording region 11 is adapted differently from that of the user data recording region 12, and the recording and reproducing apparatus for users is adapted so as not to include the error correcting code circuit and the modulation circuit for recording encryption information. This prevents the encryption key data from being copied, therefore, this makes it possible to prevent unauthorized copying.

Also, since the encryption key data is recorded in the same recording system as the data which is recorded by users, the encryption key data can be recorded merely by partly adding circuits to the recording and reproducing apparatus for users. Furthermore, recording the encryption key data and detecting the disk 1 when manufacturing it can be performed in the same apparatus (detecting apparatus for manufacturing disks). Therefore, recording disk identification information and detecting the disk 1 can be performed in a series of flows. This makes it possible to provide the detecting apparatus for manufacturing disks at low cost as well as to shorten the time (period) for manufacturing.

As described above, the method for recording and reproducing information of the present invention is the method for recording and reproducing information with respect to the recording medium including a data recording region (user data recording region) which is defined to record in a predetermined recording system and a first format, and an encryption information recording region (encryption data recording region) in which encryption information required to reproduce data recorded in the data recording region is recorded in the recording system and a second format different from the first format, the method recording and reproducing data using the recording and reproducing apparatus which can reproduce information in the recording system and the first format, or in the recording system and the second format, and can record information in the recording system and the first format, but not in the recording system and the second format, and the method recording data in the data recording region after encrypting the data using the encryption information which has been reproduced from the encryption information recording region in the recording medium, and reproducing information by decrypting the recording data which was reproduced from the encryption information recording region of the recording medium.

A recording medium of the present invention comprises: a blank region which is defined to record data in the predetermined recording system and the first format, and an encryption information recording region where the encryption information (encryption key data) required to encrypt information to be recorded at least in the blank region is recorded in the recording system, the encryption information being recorded in the second format different from the first format.

Also, the recording medium of the present invention comprises: a data recording region which is defined to record data in a predetermined recording system and the first format, and an encryption information recording region where the encryption information required to reproduce information which has been recorded at least in the data recording region is recorded in the recording system, the encryption information being recorded in the second format which makes it possible to reproduce information in a condition of better quality than the first format.

The recording medium of the present invention comprises: a data recording region which is defined to record data in a predetermined recording system and the first format, and an encryption information recording region where the encryption information required to reproduce information which has been recorded at least in the data recording region is recorded in the recording system, the encryption information being recorded in the second format of which the recording density is lower than that of the first format.

In the above-mentioned recording medium, the encryption information is recorded at the plural different positions in a circumferential direction on a disk which makes up the recording medium.

The above-mentioned recording medium includes the encryption information recording region wherein identification information for identifying each recording medium (for example, production number data) is recorded.

In the above-mentioned recording medium, a modulation system of the first format is different from that of the second format.

In the above-mentioned recording medium, an error correcting system of the first format is different from that of the second format.

The recording and reproducing apparatus of the present invention comprises reproducing means for reproducing information recorded in a predetermined recording system and n kinds of format and sole recording means for recording information only in the recording system and m (1≦m<n) format in the n kinds of format.

The recording and reproducing apparatus of the present invention is the apparatus for recording and reproducing information with respect to the recording medium, and comprises reproducing means for reproducing information in the recording system and the first format, and in the recording system and the second format, and sole recording means for recording information only in the recording system and the first format, but not in the recording system and the second format.

The method for manufacturing a recording medium of the present invention is the method for manufacturing the recording medium, and comprises the steps of: (1) detecting defects by recording and reproducing test data in the data recording region in the first format; and (2) recording the encryption information in the encryption information recording region in the second format, said step (1) and said (2) being continuously carried out in one apparatus.

The above-mentioned method for manufacturing the recording medium comprises the steps of recording the encryption information in the second format in the encryption information recording region, detecting the encryption information which is recorded, and re-recording the encryption information in case where the encryption information has not been recorded properly.

According to the method for recording and reproducing information, the recording and reproducing apparatus and the recording medium of the present invention, encryption information cannot be copied, thereby preventing unauthorized copying.

It is possible to reliably read out encryption information by recording the encryption information at plural different positions in the circumferential direction and by recording encryption information in the format which ensures to reproduce data in a condition of better quality.

Also, according to the method for manufacturing the recording medium of the present invention, the apparatus for manufacturing the recording medium (detecting apparatus for manufacturing disks) can be manufactured at low cost, and the time for manufacturing the recording medium can be shortened.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. A method for recording and reproducing information with respect to a recording medium, the recording medium including a data recording region which is defined to record information in a predetermined recording system and a first format, and an encryption data recording region in which encryption information required to reproduce data recorded in the data recording region is recorded in the recording system and a second format different from the first format,
said method recording information in the data recording region in the recording system and the first format; after encrypting the information to record using the encryption information which was reproduced in the recording system and the second format from the encryption data recording region in the recording medium, and
said method reproducing information by reading out the encrypted information recorded in the data recording region in the recording system and the first format, and by decrypting the encrypted information using the encryption information which was reproduced from the encryption data recording region in the recording medium in the recording system and the second format.

2. A recording medium comprising:
a data recording region which is defined to record data in a predetermined recording system and a first format; and
an encryption data recording region in which encryption information required to encrypt information to be recorded in the data recording region and to reproduce recorded information from the data recording region is recorded in the recording system,
wherein the encryption information is recorded in the data recording region in a second format different from the first format.

3. The recording medium according to claim 2, wherein the data recording region is blank before information is recorded by user.

4. The recording medium according to claim 2, wherein the second format is adapted to reproduce information in a condition of better quality than that of the first format.

5. The recording medium according to claim 4, wherein recording density of the second format is lower than that of the first format.

6. The recording medium according to claim 2, wherein the encryption information is recorded at the plural different positions in a circumferential direction on a disk which makes up the recording medium.

7. The recording medium according to claim 2, wherein the encryption information is set to be different in each recording medium.

8. The recording medium according to claim 2, wherein identification information for identifying each recording medium is recorded in the encryption data recording region.

9. The recording medium according to claim 4, wherein a modulation system of the first format is different from that of the second format.

10. The recording medium according to claim 4, wherein an error correcting system of the first format is different from that of the second format.

11. A recording and reproducing apparatus for recording and reproducing information with respect to a recording medium, the recording medium including a data recording region which is defined to record information in a predetermined recording system and a first format, and an encryption data recording region in which encryption information required to encrypt information to be recorded in the data recording region and to reproduce recorded data from the data recording region is recorded in the recording system, the encryption information being recorded in the data recording region in a second format different from the first format,
said recording and reproducing apparatus comprising:
reproducing means for reproducing information in the recording system and the first format, and in the recording system and the second format; and
sole recording means for recording information on the recording medium only in the recording system and the first format, but not in the recording system and the second format.

12. The recording and reproducing apparatus according to claim 11, wherein the second format is adapted to reproduce information in a condition of better quality than that of the first format.

13. The recording and reproducing apparatus according to claim 12, wherein recording density of the second format is lower than that of the first format.

14. The recording and reproducing apparatus according to claim 12, wherein a modulation system of the first format is different from that of the second format.

15. The recording and reproducing apparatus according to claim 12, wherein an error correcting system of the first format is different from that of the second format.

16. A recording and reproducing apparatus comprising:
reproducing means for reproducing information recorded in a predetermined recording system and n kinds of format; and
sole recording means for recording information only in the recording system and m (1<m<n) format in the n kinds of format.

17. A method for manufacturing a recording medium, the recording medium including a data recording region which is defined to record information in a predetermined recording system and a first format, and an encryption data recording region in which encryption information required to encrypt information to be recorded in the data recording region and to reproduce recorded information from the data recording region is recorded in the recording system and a second format different from the first format,
said method comprising the steps of:
(1) detecting defects by recording and reproducing test data in the data recording region in the first format; and
(2) recording the encryption information in the encryption data recording region in the second format,
said step (1) and said step (2) being continuously carried out in one apparatus.

18. The method for manufacturing a recording medium according to claim 17, wherein recording density of the second format is lower than that of the first format.

19. The method for manufacturing a recording medium according to claim 17, wherein the encryption information is recorded at the different plural positions in a circumferential direction on a disk which makes up the recording medium.

20. The method for manufacturing a recording medium according to claim 17, wherein the encryption information is set to be different in each recording medium.

21. The method for manufacturing a recording medium according to claim 17, wherein identification information for identifying each recording medium is recorded in the encryption data recording region.

22. The method for manufacturing a recording medium according to claim 17, wherein a modulation system of the first format is different from that of the second format.

23. The method for manufacturing a recording medium according to claim 17, wherein an error correcting system of the first format is different from that of the second format.

24. The method for manufacturing a recording medium according to claim 17, further comprising the steps of:
detecting the encryption information which is recorded in the encryption data recording region in the second format; and
re-recording the encryption information in case where the encryption information has not been recorded properly.
